(19) United States
(12) Patent Application Publication
(10) Pub. No.: US 2026/0111850 A1
(43) Pub. Date: Apr. 23, 2026

(54) DYNAMIC ASSET MAINTENANCE

(71) Applicant: INTERNATIONAL BUSINESS MACHINES CORPORATION, Armonk, NY (US)

(72) Inventors: Zhuo Zhao, Beijing (CN); Li Bo Zhang, BEIJING (CN); Yang Yang, SHANGHAI (CN); Guo Fang Yin, Shanghai (CN); Tsung Che CHIANG, Taichung City (TW); Na Lv, Changping (CN)

(21) Appl. No.: 18/919,888

(22) Filed: Oct. 18, 2024

(51) Int. Cl. G06Q 10/20; G06Q 30/0201

(52) U.S. Cl. CPC G06Q 10/20; G06Q 30/0206

(57) ABSTRACT

A computer-implemented method may include generating, by a processor set, a generative contextual model comprising a plurality of nodes; modeling, by the processor set, a solution chain based on the plurality of nodes of the generative contextual model; generating, by the processor set, a plurality of cost calculation matrixes for each node in the plurality of nodes; determining, by the processor set, a dynamic weight for each cost calculation matrix in the plurality of cost calculation matrixes; receiving, by the processor set, a user determined impact factor of the solution chain; and determining, by the processor set, a final cost based on the impact factor and a sum of the dynamic weights for each cost calculation matrix; and executing, by the processor set, the solution chain.

### BACKGROUND

Aspects of the present invention relate generally to asset maintenance tracking systems.

Asset maintenance tracking may provide previous work order history and maintenance solutions.

### SUMMARY

In a first aspect of the invention, there is a computer-implemented method including: generating, by a processor set, a generative contextual model comprising a plurality of nodes; modeling, by the processor set, a solution chain based on the plurality of nodes of the generative contextual model; generating, by the processor set, a plurality of cost calculation matrixes for each node in the plurality of nodes; determining, by the processor set, a dynamic weight for each cost calculation matrix in the plurality of cost calculation matrixes; receiving, by the processor set, a user determined impact factor of the solution chain; and determining, by the processor set, a final cost based on the impact factor and a sum of the dynamic weights for each cost calculation matrix; and executing, by the processor set, the solution chain.

In another aspect of the invention, there is a computer program product including one or more computer readable storage media having program instructions collectively stored on the one or more computer readable storage media. The program instructions are executable to: generate a generative contextual model comprising a plurality of nodes; model a solution chain based on the plurality of nodes of the generative contextual model; generate a plurality of cost calculation matrixes for each node in the plurality of nodes; determine a dynamic weight for each cost calculation matrix in the plurality of cost calculation matrixes; receive a user determined impact factor of the solution chain; and determine a final cost based on the impact factor and a sum of the dynamic weights for each cost calculation matrix; and execute the solution chain.

In another aspect of the invention, there is a system including a processor set, one or more computer readable storage media, and program instructions collectively stored on the one or more computer readable storage media. The program instructions are executable to: generate a generative contextual model comprising a plurality of nodes; model a solution chain based on the plurality of nodes of the generative contextual model; generate a plurality of cost calculation matrixes for each node in the plurality of nodes; determine a dynamic weight for each cost calculation matrix in the plurality of cost calculation matrixes; receive a user determined impact factor of the solution chain; and determine a final cost based on the impact factor and a sum of the dynamic weights for each cost calculation matrix; and execute the solution chain.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a block diagram of an exemplary environment in accordance with aspects of the present invention.

FIG. 5 shows a block diagram of an exemplary environment in accordance with aspects of the present invention.

FIG. 6 shows a block diagram of an exemplary environment in accordance with aspects of the present invention.

FIG. 7 shows a block diagram of an exemplary environment in accordance with aspects of the present invention.

FIG. 8 shows a block diagram of an exemplary environment in accordance with aspects of the present invention.

FIG. 9 shows a flowchart of an exemplary method in accordance with aspects of the present invention.

### DETAILED DESCRIPTION

Aspects of the present invention relate generally to asset maintenance tracking (AMT) systems and, more particularly, to a system, method, or computer program product for determining an optimal solution to vehicle maintenance or repairs. According to aspects of the present invention, an AMT system may receive sensor event data, such as a low-tire pressure warning, and identify a problematic asset based on the sensor event data. The AMT system may build a generative contextual model from the sensor event data. The generative contextual model may be a computer-based program configured to capture or predict outcomes based on the sensor event data and a cost calculation matrix. In embodiments, the generative contextual model is generated by associating governing equations with the sensor event data and a cost calculation matrix in order to identify solutions to the sensor event data. In embodiments, the cost calculation matrix may be generated for each node (an asset, event, material, etc.,) within the generative contextual model by compiling asset cost, repair/replacement cost, etc. The generative contextual model and cost calculation matrix may be used to identify solution chains for resolving maintenance or repairs that also consider a user budget and a user input. In embodiments, solution chains may be a single event or sequence of events, including initial events, intermediate events, and final results, of vehicle maintenance repairs or part replacements. In further embodiments, the vehicle maintenance repairs or part replacements may include costs and timing.

In conventional systems, identifying optimized maintenance solutions for vehicles is complicated by the complexity of vehicle failures. In conventional systems, service providers may require long periods of time to find the source of the problem and take appropriate steps to repair it. In some cases, repair or maintenance costs in conventional systems may complicate a decision to replace or repair components. In conventional systems, the timing of repairs and maintenance may further complicate solutions, as a customer may not desire to fully replace a broken component due to the time required.

In conventional systems, maintenance solutions are identified based on the work order history of similar problems. In conventional systems, similar problems may be selected or pre-defined solutions based on static and simple if-else conditions. However, such conventional solutions may not be the most suitable when cost is considered. In conventional systems, when determining maintenance solutions, service providers may not take into consideration specific asset and problem context and real-time running situations. Accordingly, in conventional systems, the solution cannot be optimized and calculated based on dynamic cost impact factors, which can be different and change in real-time.

Aspects of the present invention relate to a system, method, or computer program product configured to build generative contextual models to model real-time comprehensive solution chains based on work order history and domain knowledge. The system may build cost calculation matrixes for each node in the generative contextual model to evaluate maintenance options, adaptively discover solution chain and trace-back based on real-time dynamic context sensor or resource data, evaluate maintenance options based on a flexible cost impact factor and dynamic real-time sensor or data by leveraging the generative contextual model and cost calculation matrix, and provide transparent history trace to identify a solution chain.

As a non-limiting example, a vehicle may not start due to an unknown system failure or breakdown. The AMT system may receive vehicle sensor event data, such as an indication that the vehicle does not start. In some cases, the vehicle sensor event data may include specific details relating to a malfunctioning part or function, such as an electrical failure of a specific fuse, battery, alternator, etc. The AMT system may identify a problematic asset based on the sensor event data, e.g., sensor data indicates that the resistance of an ignition switch is not in acceptable range, a magnetic pickup is malfunctioning, or both. The AMT system may build a generative contextual model from the sensor event data including solution chains comprising a node for each asset, event, material, etc., of the vehicle, including attributes of the node and a machine learning model configured to generate the context of the node based on domain knowledge (published manuals, technical descriptions, etc.) and working history (past service history of the asset, event, material etc. associated with the node). Each node of the generative contextual model may include any number of edges linking nodes together based on linkage types (root causes, material consumption, etc.), activation criteria (resources needed, safety considerations, sensor thresholds, etc.), source nodes, and target nodes. The generative contextual model may be a computer-based program configured to capture or predict outcomes based on the sensor event data and a cost calculation matrix. In embodiments the generative contextual model is generated by associating governing equations with the nodes and edges to identify solutions to the sensor event data. In embodiments, the cost calculation matrix may be generated for each node (an asset, event, material, etc.,) within the generative contextual model by compiling asset cost, repair/replacement cost, etc., in a table. Each node and corresponding cost calculation matrix may be a potential solution to the problem of the vehicle not starting (or any other malfunction or defective part or assembly). For example, a node may include a specific fuse as an asset and the cost calculation matrix indicates a low cost to replace the fuse based on historical repair data. In some embodiments, solution chains consist of multiple nodes and edges as a series of repair or replacement steps identified as a time and cost-effective solution.

In some embodiments, a user impact factor may be integrated into the cost calculation matrix to identify nodes that fit within the user's repair budget. For example, a dynamic weight for each cost calculation matrix in the plurality of cost calculation matrixes may be determined based on the user impact factor. The dynamic weight may be determined by comparing matching matrix vectors (rows or columns) to the total matrix vector count. For example, a cost calculation matrix may include vectors associated with each of the nodes and linkages of the generative contextual model. Vectors may be compared to each solution chain's nodes and edges to identify a high overlap, indicating a high dynamic weight. Alternatively, vectors having low overlap with solution chains' nodes and edges would have a corresponding low dynamic weight. A final cost may be determined based on the impact factor and a sum of the dynamic weights for each cost calculation matrix in a solution chain.

In embodiments, a computer-implemented method may include generating, by a processor set, a generative contextual model comprising a plurality of nodes; modeling, by the processor set, a solution chain based on the plurality of nodes of the generative contextual model; generating, by the processor set, a plurality of cost calculation matrixes for each node in the plurality of nodes; determining, by the processor set, a dynamic weight for each cost calculation matrix in the plurality of cost calculation matrixes; receiving, by the processor set, a user determined impact factor of the solution chain; and determining, by the processor set, a final cost based on the impact factor and a sum of the dynamic weights for each cost calculation matrix; and executing, by the processor set, the solution chain.

In embodiments, a computer-implemented method may include generating, by a processor set, the generative contextual model comprising the plurality of nodes based on received sensor event data of a vehicle. Aspects of the present invention improve the process of solution chain identification based on vehicle sensor data.

In embodiments, a computer-implemented method may include a dynamic weight determined by dividing a total vector count by a matched vector count. Aspects of the present invention improve the process of solution chain identification by dynamically weighting relevant factors of the solution chain.

In embodiments, a computer-implemented method may include building a plurality of generative contextual models for each node in the plurality of nodes. Aspects of the present invention improve the process of solution chain identification by predicting, via contextual model, solution chains that are or are not viable options.

In embodiments, a computer-implemented method may include a generative contextual model comprises associating governing equations, the via the machine learning model, between the domain knowledge and the work history and extrapolating solution chains based on the governing equations. Aspects of the present invention improve the process of solution chain identification by implementing machine learning to improve future solution chain identification.

In embodiments, a computer-implemented method may include training the machine learning model based on the solution chain, the plurality of generative contextual models, and the plurality of cost calculation matrixes to improve the accuracy of the generating the generative contextual model. Aspects of the present invention improve the process of solution chain identification by implementing machine learning to improve future solution chain identification.

In embodiments, a computer-implemented method may include adjusting each cost calculation matrix in the plurality of cost calculation matrixes based on the received impact factor. Aspects of the present invention improve the process of solution chain identification by incorporating user impact factors, thereby reducing the number of non-feasible solution chains that are output by the method.

In embodiments, a computer-implemented method may include determining a new final cost based on the received impact factor and a sum of each dynamic weight for each adjust cost calculation matrix. Aspects of the present invention improve the process of solution chain identification by calculating final costs associated with a solution chain based on varying user decided impact factors and system identified dynamic weights.

In embodiments, a computer-implemented method may include a plurality of nodes, wherein each node comprises an object name and an object type, and the generative contextual model comprises one or more edges linking each node in the plurality of nodes to another node based on linkage types. Aspects of the present invention improve the process of solution chain identification by dynamically linking nodes and edges to form a solution chain address a vehicle maintenance event.

In embodiments, a computer program product comprising one or more computer readable storage media having program instructions collectively stored on the one or more computer readable storage media, the program instructions executable to: generate a generative contextual model comprising a plurality of nodes; model a solution chain based on the plurality of nodes of the generative contextual model; generate a plurality of cost calculation matrixes for each node in the plurality of nodes; determine a dynamic weight for each cost calculation matrix in the plurality of cost calculation matrixes; receive a user determined impact factor of the solution chain; and determine a final cost based on the impact factor and a sum of the dynamic weights for each cost calculation matrix; and execute the solution chain.

In embodiments, a computer program product may include generating, by a processor set, the generative contextual model comprising the plurality of nodes based on received sensor event data of a vehicle. Aspects of the present invention improve the process of solution chain identification based on vehicle sensor data.

In embodiments, a computer program product may include a dynamic weight determined by dividing a total vector count by a matched vector count. Aspects of the present invention improve the process of solution chain identification by dynamically weighting relevant factors of the solution chain.

In embodiments, a computer program product may include building a plurality of generative contextual models for each node in the plurality of nodes. Aspects of the present invention improve the process of solution chain identification by predicting, via contextual model, solution chains that are or are not viable options.

In embodiments, a computer program product may include generating the generative contextual model comprises associating governing equations, the via the machine learning model, between the domain knowledge and the work history and extrapolating solution chains based on the governing equations. Aspects of the present invention improve the process of solution chain identification by implementing machine learning to improve future solution chain identification.

In embodiments, a computer program product may include training the machine learning model based on the solution chain, the plurality of generative contextual models, and the plurality of cost calculation matrixes to improve the accuracy of generating the generative contextual model. Aspects of the present invention improve the process of solution chain identification by implementing machine learning to improve future solution chain identification.

In embodiments, a computer program product may include adjusting each cost calculation matrix in the plurality of cost calculation matrixes based on the received impact factor. Aspects of the present invention improve the process of solution chain identification by incorporating user impact factors, thereby reducing the number of non-feasible solution chains that are output by the method.

In embodiments, a computer program product may include determining a new final cost based on the received impact factor and a sum of each dynamic weight for each adjust cost calculation matrix. Aspects of the present invention improve the process of solution chain identification by calculating final costs associated with a solution chain based on varying user decided impact factors and system identified dynamic weights.

In embodiments, a computer program product may include a plurality of nodes, wherein each node comprises an object name and an object type, and the generative contextual model comprises one or more edges linking each node in the plurality of nodes to another node based on linkage types. Aspects of the present invention improve the process of solution chain identification by dynamically linking nodes and edges to form a solution chain address a vehicle maintenance event.

In embodiments, a system may include a processor set, one or more computer readable storage media, and program instructions collectively stored on the one or more computer readable storage media, the program instructions executable to: generate a generative contextual model comprising a plurality of nodes; model a solution chain based on the plurality of nodes of the generative contextual model; generate a plurality of cost calculation matrixes for each node in the plurality of nodes; determine a dynamic weight for each cost calculation matrix in the plurality of cost calculation matrixes; receive a user determined impact factor of the solution chain; and determine a final cost based on the impact factor and a sum of the dynamic weights for each cost calculation matrix; and execute the solution chain.

In embodiments, a system may include generating the generative contextual model comprising the plurality of nodes based on received sensor event data of a vehicle. Aspects of the present invention improve the process of solution chain identification based on vehicle sensor data.

Implementations of the invention involves the technical field of asset management systems including managing volumes of data measured and communicated over a network, generating complex generative contextual models, utilizing machine learning models, and are therefore necessarily rooted in computer technology. For example, the steps of generating a generative contextual model comprising a plurality of nodes; modeling a solution chain based on work order history and domain knowledge; generating a plurality of cost calculation matrixes on each node in the plurality of nodes; determining a dynamic weight for each cost calculation matrix in the plurality of cost calculation matrixes; and determining a final cost based on the impact factor and a sum of the dynamic weights for each cost calculation matrix are computer-based and cannot be performed in the human mind. Additionally, the steps involved in the implementation of the present invention amount to more than merely implementing the generic computer as a tool to gather, analyze, and output data because the steps reduce the computing resources necessary to analyze a multitude of solution chains and user input in real-time. Similarly, implementations of the invention would be impossible to accomplish on pen and paper due to the volume of data being measured, calculated, and communicated over a network in real-time. In particular, the speed at which the measuring, calculation, and communication of data occurs in order to effectuate the disclosed method, system, or computer program product would involve large-scale, continuous monitoring, calculation, and wireless communication of such data. These features would be impossible to accomplish on pen and paper and cannot be accomplished as a method of organizing human activity.

Implementations of the invention involve artificial intelligence modeling technology and machine learning to generate the context of nodes in a generative contextual model based on domain knowledge and working history. Training and using a machine learning model are, by definition, performed by a computer and cannot practically be performed in the human mind (or with pen and paper) due to the complexity and massive amounts of calculations involved. Additionally, for example, a machine learning model may be trained using a large amount of historical and real time data. Thus, the trained model generates an output in real time (or near real time) using the large amount of historical and real time data. Given this scale and complexity, it is simply not possible for the human mind, or for a person using pen and paper, to perform the number of calculations involved in training and/or using a machine learning model.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic asset maintenance code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

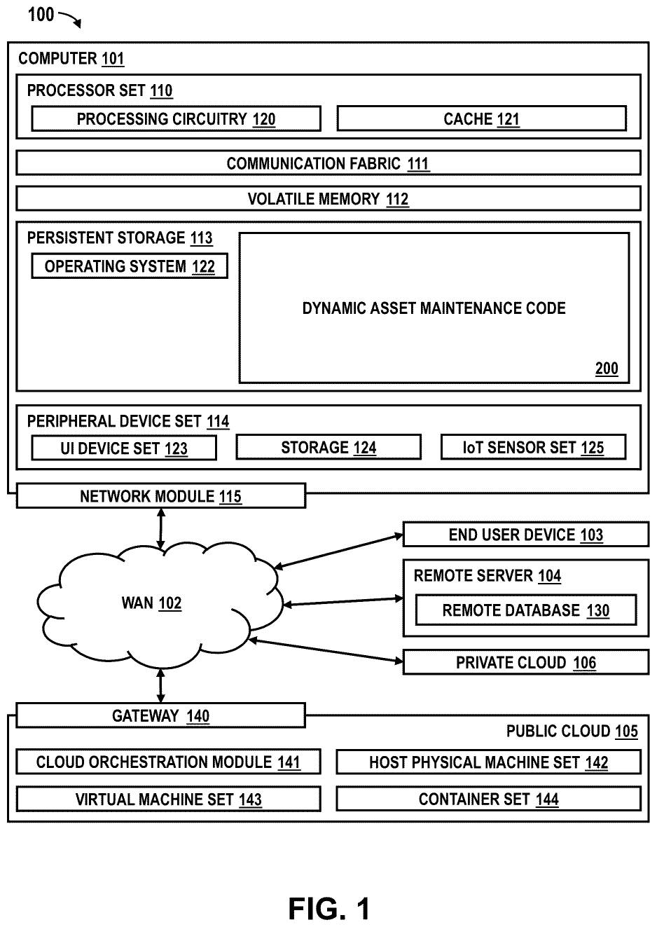

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

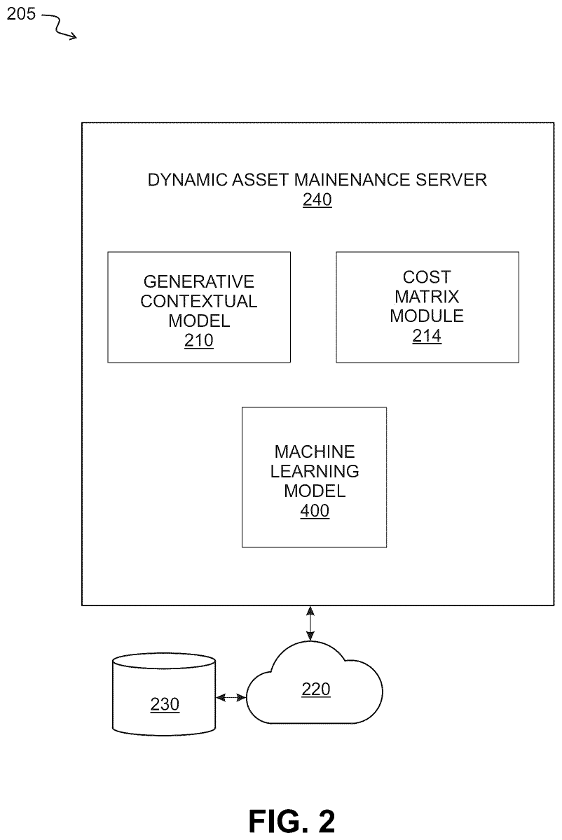

FIG. 2 shows a block diagram of an exemplary environment 205 in accordance with aspects of the invention. In embodiments, the environment 205 includes a dynamic asset maintenance server 240 corresponding to the computer 101 of FIG. 1. In embodiments, the dynamic asset maintenance server 240 of FIG. 2 comprises a generative contextual model 210, a cost matrix module 214, and a machine learning model 400, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The dynamic asset maintenance server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In embodiments, the dynamic asset maintenance server 240 may be in operable communication with a database 230, corresponding to remote database 130 depicted in FIG. 1, over network 220, corresponding to WAN 102 depicted in FIG. 1. In practice, the environment may include additional devices and/or networks; fewer devices and/or networks; different devices and/or networks; or differently arranged devices and/or networks than illustrated in FIG. 2.

The machine learning model 400 may be, for example, a large language model such as ChatGPT, that receives text values within domain knowledge and work history as inputs and outputs text relating to known repairs or part replacements, known non-effective repairs or part replacements, costs and timing associated with repairs and replacements, etc. The machine learning model 400 generates text, for example, based on a generative trained transformer algorithm. The machine learning model 400 may be configured to provide, as input to the generative contextual model 210, the output text relating to known repairs or part replacements, etc. The machine learning model 400 may be configured to generate the generative contextual model 210, which may be a computer-based program configured to capture or predict outcomes of solution chains based on domain knowledge (published manuals, technical descriptions, etc.) and working history (past service history of the asset, event, material, etc. associated with the node). Domain knowledge and work history may be stored, for example, in database 230 corresponding to remote database 130 depicted in FIG. 1. In embodiments, the generative contextual model 210 may be generated by associating governing equations with each of the domain knowledge and work history and extrapolating solution chains to identify the best solution to a repair or part replacement event. Governing equations may be any rules describing the interaction between variables in the model. The machine learning model 400 may identify solution chains within the generative contextual model comprising nodes and edges based on domain knowledge and working history. In embodiments, the machine learning model 400 may be trained on a plurality of solution chains, a plurality of pre-generated generative contextual models, and a plurality of cost calculation matrixes to improve the accuracy of generating the generative contextual model. For example, training the machine learning model 400 on executing solution chains and their corresponding generative contextual models and cost calculation matrixes may improve the likelihood a correct solution train is identified based on historical data of executing a particular solution chain.

The generative contextual model 210 may include any number of edges linking nodes together based on linkage types (root causes, material consumption, etc.), activation criteria (resources needed, safety considerations, sensor thresholds, etc.), source nodes, and target nodes. The generative contextual model 210 may be a computer-based program configured to model and predict solution chains based on the sensor event data, domain knowledge, work history, and cost calculation matrixes. The generative contextual model 210 may be configured to model solution chains based on work order history and domain knowledge by linking nodes to edges in, for example, a knowledge graph. The generative contextual model 210 may link nodes to edges by analyzing text values, such as via the machine learning model 400, within domain knowledge and work history, including known repairs or part replacements, known non-effective repairs or part replacements, costs and timing associated with repairs and replacements, etc. Linking nodes to edges may include mapping a knowledge graph containing the nodes and associated edges.

The cost matrix module 214 may generate a plurality of cost calculation matrixes for each node in the plurality of nodes, wherein nodes and edges include data associated with cost and time of repair. Cost calculation matrixes may sum costs per node or edge, or costs associated with a whole solution chain consisting of multiple nodes and edges. In embodiments, a cost calculation matrix may be generated via the cost matrix module 214 for each node (an asset, event, material, etc.,) within the generative contextual model 210 by compiling asset cost, repair/replacement cost, etc., in a table. Each node and corresponding cost calculation matrix may be a potential solution to the problem of the vehicle not starting. For example, a node may include a specific fuse as an asset and the cost calculation matrix indicates a low cost to replace the fuse based on historical repair data. The cost matrix module 214 may determine a dynamic weight for each cost calculation matrix in the plurality of cost calculation matrixes by receiving an impact factor (a user determined variable, e.g., a user maximum repair budget) of the solution chain and identifying solution chains not complying with the impact factor. For example, solution chains with a summed cost above a user maximum repair budget may not comply with the impact factor and are removed from consideration as a solution chain. Dynamic weights may be determined based on a comparison between nodes and a maintenance event. For example, a high dynamic weight may be applied to nodes, including repair information relevant to an identified maintenance event measured via sensor event data, such as a vehicle's failure to start. The cost matrix module 214 may also determine a final cost based on the impact factor and a sum of the dynamic weights for each cost calculation matrix. In this way, the cost matrix module 214 may identify the best option (solution chain) for addressing a sensor abnormal event, including generating the plurality of cost calculation matrixes, determining dynamic weights for each cost calculation matrix, identify solution chains complying with an impact factor, and selecting the solution chain complying with an impact factor having the lowest final cost.

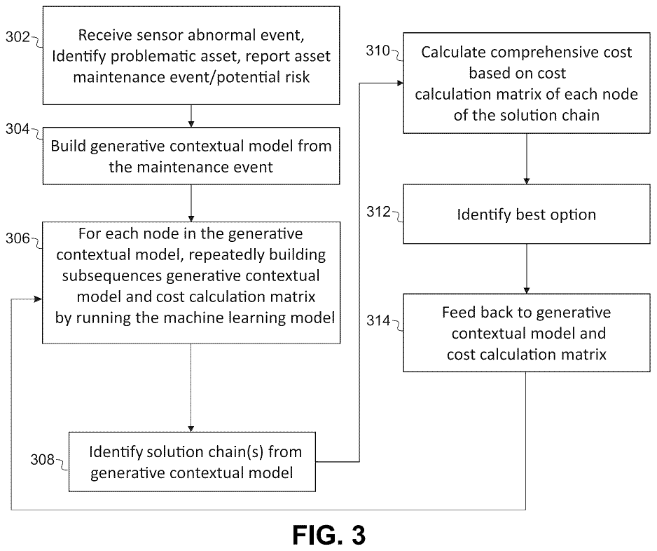

FIG. 3 shows a flowchart of an exemplary method in accordance with aspects of the present invention. The dynamic asset maintenance server 240 of FIG. 2 may be configured to, in step 302, receive sensor abnormal event, identify problematic assets, and report asset maintenance events or potential risks via the machine learning model 400 of FIG. 2. In step 304, the dynamic asset maintenance server may build a generative contextual model 210 as in FIG. 2, via the machine learning model 400 of FIG. 2. In step 306, the dynamic asset maintenance server may, for each node in the generative contextual model, repeatedly build subsequence generative contextual models via the machine learning model 400 of FIG. 2 and cost calculation matrixes via the cost matrix module 214 of FIG. 2. In step 308, the dynamic asset maintenance server may identify solution chains from the generative contextual model that align with user impact factors, via the cost matrix module 214 of FIG. 2. In step 310, the dynamic asset maintenance server may calculate comprehensive costs based on the cost calculation matrixes of each node of the solution chains, via the cost matrix module 214 of FIG. 2. In step 312, the dynamic asset maintenance server may identify the best option (solution chain) for addressing the sensor abnormal event, via the cost matrix module 214 of FIG. 2. In step 314, the dynamic asset maintenance server may communicate the identified best option as feedback to the generative contextual model and cost calculation matrix, via the cost matrix module 214 and the machine learning model 400 of FIG. 2. In embodiments, the machine learning model 400 may be trained based on the feedback including the best option, solution chains, generative contextual model, and cost calculation matrixes.

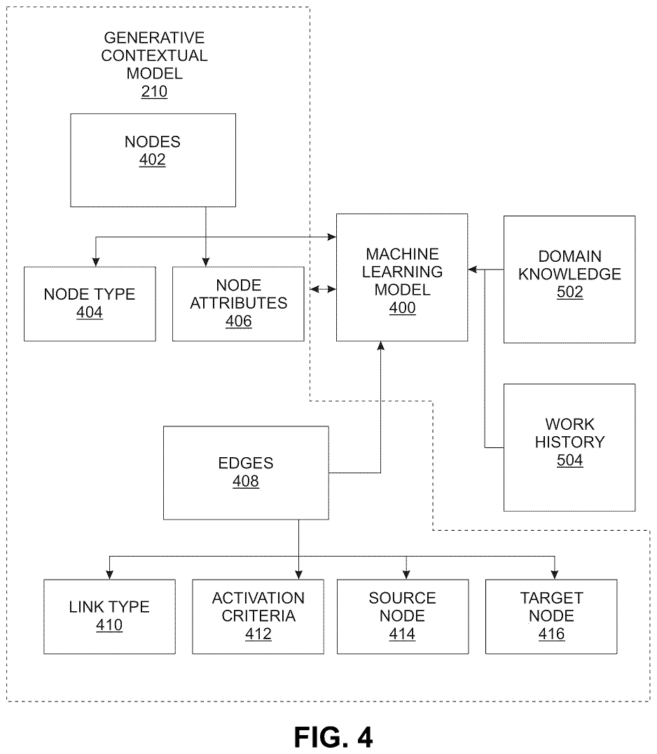

FIG. 4 shows a block diagram of an exemplary environment in accordance with aspects of the present invention. The machine learning model 400 may be configured to analyze text values within domain knowledge 502 and work history 504. The machine learning model 400 may be configured to generate the generative contextual model 210, including nodes 402 and edges 408. Nodes 402 may include node type 404, such as a vehicle part category, and node attributes 406, such as specific properties associated with node 402. Edges 408 may define link types 410 (relationships) between nodes 402, such as source node 414 and target node 416. For example, node 402 may include target nodes 416 “tire” and “rim,” and edge 408 may include source node 414 “parts of a wheel,” thereby establishing the relationship between a tire and a rim as parts of a larger assembly, a wheel. In embodiments, edges 408 may include activation criteria 412 (e.g., metadata) indicating that the machine learning model 400 should or should not analyze text values associated with the edge 408 and linked nodes 402. Activation criteria 412 may indicate that node 402 linked to edges 408, for example, includes a safety protocol, resource requirements, sensor thresholds, or other data relevant to the object associated with node 402. For example, activation criteria 412 may include metadata linking a node associated with tire repairs and a node associated with a tire pressure sensor. In further embodiments, the metadata includes information regarding optimal tire pressure when driving in rainy weather.

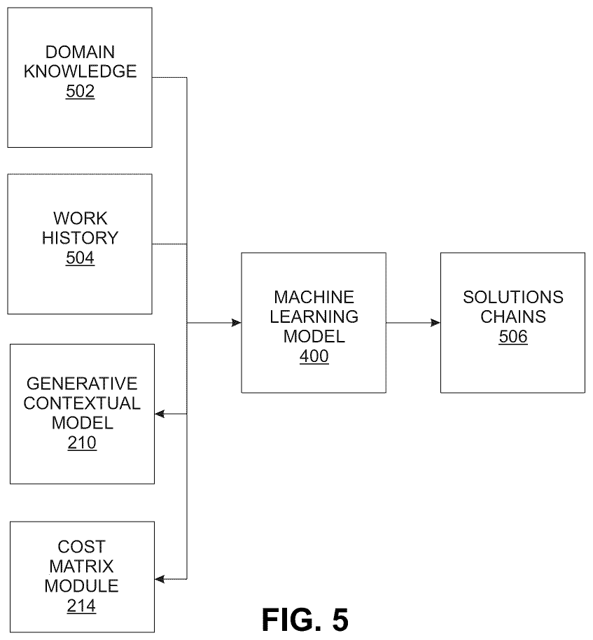

FIG. 5 shows a block diagram of an exemplary environment in accordance with aspects of the present invention. The machine learning model 400 may be configured to generate the generative contextual model 210 depicted in FIG. 4, which may be configured to predict outcomes of solution chains 506 based on domain knowledge 502 and work history 504. Solution chains 506 may be a single event or sequence of events, including initial events, intermediate events, and final results, represented as nodes 402 of FIG. 4, of vehicle maintenance repairs or part replacements including costs and timing. Solution chains 506 may include edges 408 and activation criteria 412 of FIG. 4, including relevant information which link nodes 402.

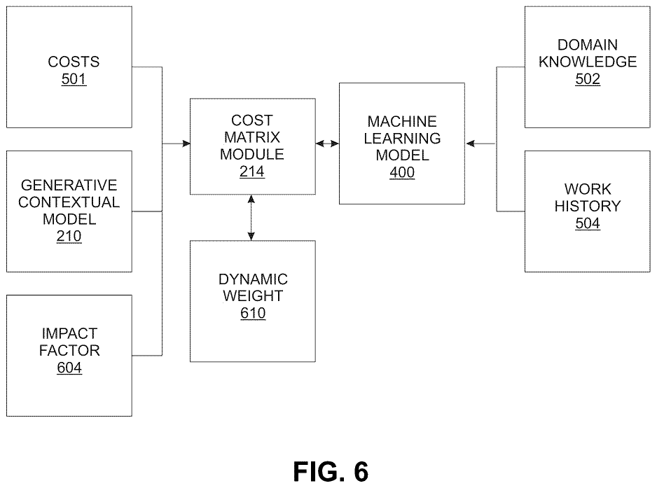

FIG. 6 shows a block diagram of an exemplary environment in accordance with aspects of the present invention. The cost matrix module 214 may generate a plurality of cost calculation matrixes for each node in the generative contextual model 210 of FIG. 5. Cost calculation matrixes may sum costs 501 per node or edge, or costs 501 associated with a whole solution chain. The cost matrix module 214 may determine a dynamic weight 610 for each cost calculation matrix in the plurality of cost calculation matrixes by receiving an impact factor 604 of the solution chain (e.g., a user maximum repair budget) and identifying solution chains not complying with the impact factor 604. The impact factor 604 may be a user input, such as a maximum cost of repair or part replacement. Dynamic weights 610 may be determined based on a comparison between nodes and a maintenance event by the cost matrix module 214. For example, a low dynamic weight may be applied to nodes in a cost calculation matrix, including repair information that is irrelevant to an identified maintenance event measured via sensor event data, such as a vehicle's failure to start. A high dynamic weight may be applied to nodes, including repair information that is highly relevant to an identified maintenance event, such as the vehicle's failure to start. In embodiments, the cost calculation matrix may be generated via the cost matrix module 214 for each node (an asset, event, material, etc.,) within the generative contextual model by compiling asset cost, repair/replacement cost, etc., in a table.

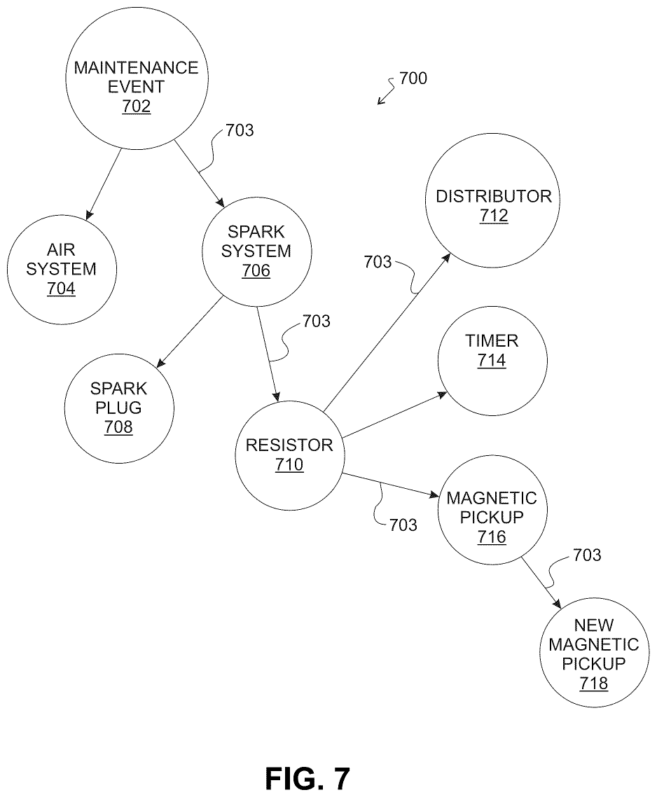

FIG. 7 shows a block diagram of an exemplary environment in accordance with aspects of the present invention. The block diagram of FIG. 7 depicts a solution chain 700 generated by the generative contextual model 210 of FIG. 6, including a plurality of nodes and edges 703. The solution chain 700 may include a maintenance event 702 such as a “failure to start vehicle” based on sensor data from a vehicle. The solution chain may link, via edges 703, the maintenance event 702 to relevant nodes by associating the maintenance event 702 with relevant nodes based on relationships defined by edges 703. For example, the “failure to start vehicle” maintenance event 702 may be correlated to an air system 704 failure or a spark system 706 failure. Edges 703 may further relate “sub-nodes” in the solution chain 700 such as spark plug 708 or resistor 710 as possible solutions to the maintenance event 702. In this way, the solution chain 700 may graph relevant nodes and edges. Each node may include data associated with an object of the node, such as an object name and an object type. For example, resistor 710 may include a high cost and low time requirement to repair and spark plug 708 may include a low cost and high time requirement to replace. Accordingly, the generative contextual model may generate the solution chain to include alternative, viable repair or replacement solutions. As an example, the generative contextual model may map the distributor 712, timer 714, and magnetic pickup 716 as feasible solutions to repairing parts of a vehicle instead of replacing the resistor 710, which may be costly and time-consuming. The generative contextual model may map additional nodes and edges to, for example, identify a potential solution to maintenance event 702 as a lowest cost and fastest repair as a potential solution. In this example, the generative contextual model 210 generates a solution chain 700 identifying a replacement new magnetic pickup 718 as a lowest cost and fastest repair as a potential solution to the maintenance event 702.

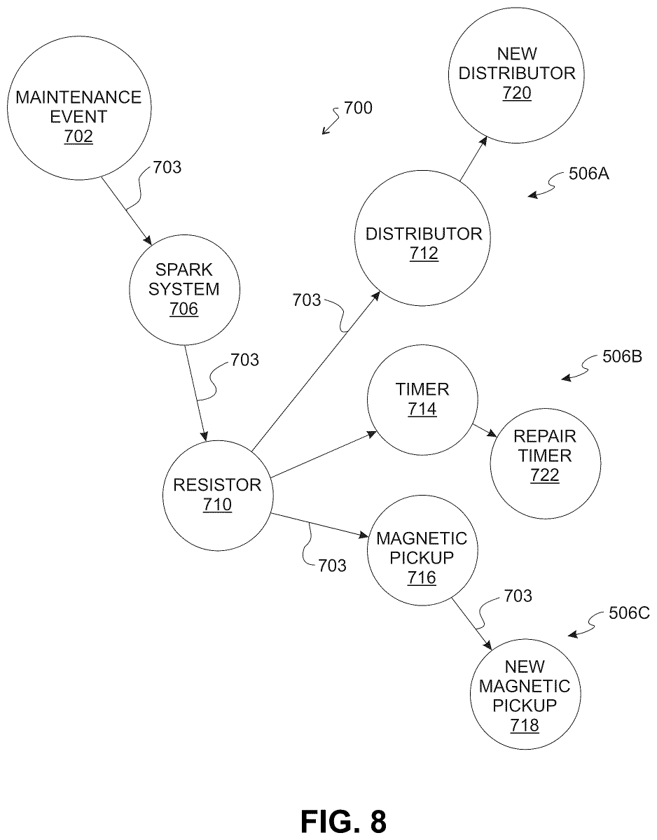

FIG. 8 shows a block diagram of an exemplary environment in accordance with aspects of the present invention. Similar to FIG. 7, a solution chain 700 is generated by the generative contextual model 210 of FIG. 6, including a plurality of nodes and edges 703. The solution chain 700 may include a maintenance event 702 such as “failure to start vehicle” based on sensor data from a vehicle. The solution chain may link, via edges 703, the maintenance event 702 to relevant nodes by associating the maintenance event 702 with relevant nodes based on relationships defined by edges 703. Edges 703 may further relate “sub-nodes” in the solution chain 700 such as resistor 710 as a possible solution to the maintenance event 702. In this way, the solution chain 700 may graph relevant nodes and edges. Accordingly, the generative contextual model 210 may generate the solution chain to include alternative, viable repair or replacement solutions depicted as alternative solution chains 506A, 506B, and 506C. In this example, the generative contextual model generates alternative solution chains 506A, 506B, and 506C identifying a replacement new magnetic pickup 718, repair timer 722, and new distributor 720 as potential respective solutions to the maintenance event 702.

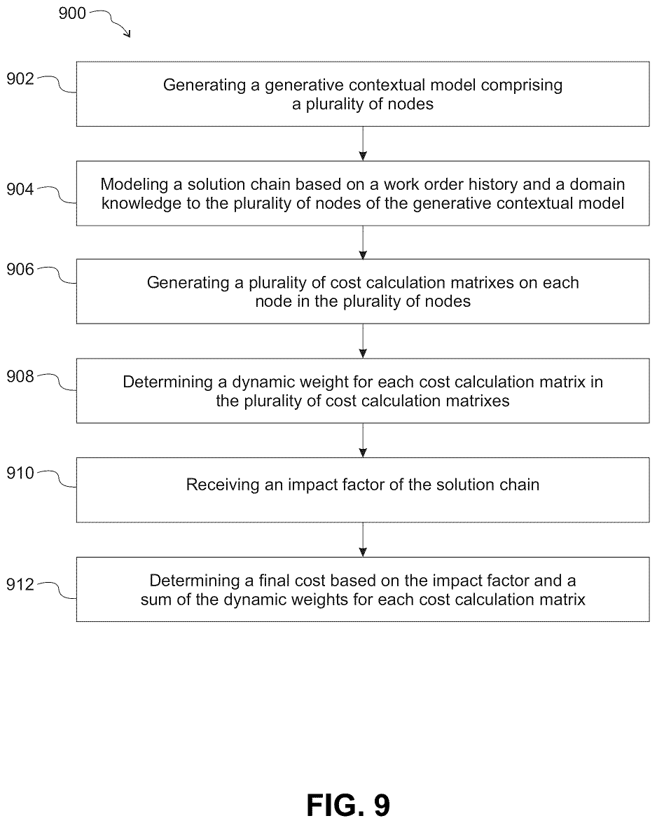

FIG. 9 shows a flowchart of an exemplary method 900 in accordance with aspects of the present invention. Step 902 of the exemplary method 900 may include generating a generative contextual model 210 comprising a plurality of nodes via the machine learning model 400 of FIG. 2. Step 904 may include modeling a solution chain based on a work order history and a domain knowledge to the plurality of nodes of the generative contextual model 210 via the machine learning model 400 of FIG. 2. In some embodiments, modeling a solution chain may include building sequential nodes of the generative contextual model 210 based on real-time sensor data from a vehicle. In various embodiments, when modeling a solution chain, the system may repeatedly build subsequence nodes based on the generative contextual model based on the real-time reading/sensor data. In these embodiments, when the real-time reading/sensor data changes, the generated solution chain may change due to activation criteria and the generative contextual model. Step 906 may include generating a plurality of cost calculation matrixes on each node in the plurality of nodes via the cost matrix module 214 of FIG. 2. Step 908 may include determining a dynamic weight for each cost calculation matrix in the plurality of cost calculation matrixes via the cost matrix module 214 of FIG. 2. Step 910 may include receiving an impact factor of the solution chain via the cost matrix module 214 of FIG. 2. Step 912 may include determining a final cost based on the impact factor and a sum of the dynamic weights for each cost calculation matrix via the cost matrix module 214 of FIG. 2.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating, by a processor set, a generative contextual model comprising a plurality of nodes;
modeling, by the processor set, a solution chain based on the plurality of nodes of the generative contextual model;
generating, by the processor set, a plurality of cost calculation matrixes for each node in the plurality of nodes;
determining, by the processor set, a dynamic weight for each cost calculation matrix in the plurality of cost calculation matrixes;
receiving, by the processor set, a user determined impact factor of the solution chain;
determining, by the processor set, a final cost based on the impact factor and a sum of the dynamic weights for each cost calculation matrix; and
executing, by the processor set, the solution chain.

2. The computer-implemented method of claim 1, wherein the generating the generative contextual model comprising the plurality of nodes is based on received sensor event data of a vehicle.

3. The computer-implemented method of claim 1, wherein the dynamic weight is determined by dividing a total vector count by a matched vector count.

4. The computer-implemented method of claim 1, further comprising building a plurality of generative contextual models for each node in the plurality of nodes.

5. The computer-implemented method of claim 4, wherein the generating the generative contextual model comprises:
associating governing equations, via a machine learning model, between a domain knowledge and a work history of the plurality of nodes; and
extrapolating solution chains based on the associated governing equations to generate the generative contextual model.

6. The computer-implemented method of claim 5, further comprising training the machine learning model based on the solution chain, the plurality of generative contextual models, and the plurality of cost calculation matrixes to improve an accuracy of the generating the generative contextual model.

7. The computer-implemented method of claim 1, further comprising adjusting each cost calculation matrix in the plurality of cost calculation matrixes based on the received impact factor.

8. The computer-implemented method of claim 7, further comprising determining a new final cost based on the received impact factor and a sum of each dynamic weight for each adjust cost calculation matrix.

9. The computer-implemented method of claim 1, wherein each node in the plurality of nodes comprises an object name and an object type, and the generative contextual model comprises one or more edges linking each node in the plurality of nodes to another node based on linkage types.

10. A computer program product comprising one or more computer readable storage media having program instructions collectively stored on the one or more computer readable storage media, the program instructions executable to:
generate a generative contextual model comprising a plurality of nodes;
model a solution chain based on the plurality of nodes of the generative contextual model;
generate a plurality of cost calculation matrixes for each node in the plurality of nodes;
determine a dynamic weight for each cost calculation matrix in the plurality of cost calculation matrixes;
receive a user determined impact factor of the solution chain;
determine a final cost based on the impact factor and a sum of the dynamic weights for each cost calculation matrix; and
execute the solution chain.

11. The computer program product of claim 10, wherein the generating the generative contextual model comprising the plurality of nodes is based on received sensor event data of a vehicle.

12. The computer program product of claim 10, wherein the dynamic weight is determined by dividing a total vector count by a matched vector count.

13. The computer program product of claim 10, wherein the program instructions are executable to:
build a plurality of generative contextual models for each node in the plurality of nodes.

14. The computer program product of claim 13, wherein the generating the generative contextual model comprises:
associating governing equations, via a machine learning model, between a domain knowledge and a work history; and
extrapolating solution chains based on the associated governing equations to generate the generative contextual model.

15. The computer program product of claim 14, wherein the program instructions are executable to:
train the machine learning model based on the solution chain, the plurality of generative contextual models, and the plurality of cost calculation matrixes to improve an accuracy of the generating the generative contextual model.

16. The computer program product of claim 10, wherein the program instructions are executable to:
adjust each cost calculation matrix in the plurality of cost calculation matrixes based on the received impact factor.

17. The computer program product of claim 16, wherein the program instructions are executable to:
determine a new final cost based on the received impact factor and a sum of each dynamic weight for each adjust cost calculation matrix.

18. The computer program product of claim 10, wherein each node in the plurality of nodes comprises an object name and an object type, and the generative contextual model comprises one or more edges linking each node in the plurality of nodes to another node based on linkage types.

19. A system comprising:
a processor set, one or more computer readable storage media, and program instructions collectively stored on the one or more computer readable storage media, the program instructions executable to:
generate a generative contextual model comprising a plurality of nodes;
model a solution chain based on the plurality of nodes of the generative contextual model;
generate a plurality of cost calculation matrixes for each node in the plurality of nodes;
determine a dynamic weight for each cost calculation matrix in the plurality of cost calculation matrixes;
receive a user determined impact factor of the solution chain;
determine a final cost based on the impact factor and a sum of the dynamic weights for each cost calculation matrix; and
execute the solution chain.

20. The system of claim 19, wherein the generating the generative contextual model comprising the plurality of nodes is based on received sensor event data of a vehicle.
